(19) United States
(12) Patent Application Publication
(10) Pub. No.: US 2010/0320832 A1
(43) Pub. Date: Dec. 23, 2010

(54) WHEEL BEARING FOR VEHICLE AXLES

(76) Inventors: Werner Weigand, Bessenbach (DE); Claas Dohrmann, Borstel (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/817,351

(22) Filed: Jun. 17, 2010

(30) Foreign Application Priority Data
Jun. 22, 2009 (DE) 10 2009 027 078.7

(51) Int. Cl. B60B 27/02; B60B 27/00; F16C 19/00

(52) U.S. Cl. 301/110

(57) ABSTRACT

The invention relates to a wheel bearing for vehicle axles, in particular of a commercial vehicle or a land vehicle, comprising an axle body (2), a hub assembly (4), which is arranged at the axle body (2), a fastening element (6) to fix the hub assembly (4) to the axle body (2), and an intermediate element (8), wherein the intermediate element (8) is arranged untwistably at the axle body (2) and provided between the fastening element (6) and the hub assembly (4).

### CLAIM OF PRIORITY

This application claims priority under 35 U.S.C. §119 to Application Serial No. 10 2009 027 078.7 filed in Germany on Jun. 22, 2009.

### FIELD OF THE INVENTION

The present invention relates to a wheel bearing for vehicle axles, in particular of a commercial vehicle or a land vehicle.

### BACKGROUND OF THE INVENTION

Such wheel bearings for vehicle axles are well-known in the prior art. DE 199 13 024 A1, for example, discloses a wheel bearing for vehicle axles having a hub which is rotatably supported on an axle journal by means of rolling contact bearings, wherein the hub is held by a hub axle nut screwed onto the free end of the axle journal. However, a disadvantage of such wheel bearings is that they can become loose during operation due to vibrations and forces or torques acting on the hub axle nut while the vehicle is in motion so that the hub assembly is no longer safely secured to the axle body, which might result in dangerous situations for the vehicle.

### SUMMARY OF THE INVENTION

Therefore, it is an object of the present invention to provide a wheel bearing for vehicle axles, in particular of a commercial vehicle or a land vehicle, which wheel bearing is insensitive to vibrations and ensures a safe fastening of the hub assembly irrespective of the loosening forces or torques acting on the wheel bearing.

This object is achieved by a wheel bearing for vehicle axles, in particular of a commercial vehicle or a land vehicle, exhibiting the features of claim 1. Preferred embodiments can be found in the dependent claims.

According to the invention there is provided a wheel bearing for vehicle axles, in particular of a commercial vehicle or a land vehicle, comprising an axle body, a hub assembly, which is arranged at the axle body, a fastening element to fix the hub assembly to the axle body, and an intermediate element, wherein the intermediate element is arranged untwistably at the axle body and provided between the fastening element and the hub assembly. The wheel bearing, thus, serves to mount a wheel on a vehicle axle or on an axle body of a vehicle, respectively, in particular of an agricultural machine. These machines are in particular semi-trailers, for example, which are pulled by a truck in order to transport heavy loads, or commercial vehicles in the form of trucks themselves. Expediently, the wheel bearing or hub assembly, respectively, can be arranged at one end or end region, respectively, of the axle body, like an axle stub. The axle stub can be an integral or one-piece component of the axle body or the vehicle axle, respectively. The vehicle axle is arranged in the vehicle such that it does not turn or rotate relative to the vehicle. To put it differently, the axle body is expediently not designed as a rotating shaft. This is necessary because a braking system can be arranged at the axle body so that braking forces and torques acting from the turning wheel can be transferred into the axle body and can be transmitted from the axle body into the vehicle or chassis, respectively. Expediently, a hub assembly is provided at which the vehicle wheel or the tire, respectively, is arranged. In this case, the hub assembly is expediently fastened at a distal end of the axle body by means of a fastening element. It is particularly preferable if two such wheel bearings are provided on one axle body, i.e. at both end regions of the axle body (i.e. at its left-hand end and at its right-hand end). By means of the fastening elements the hub assembly is fixed to the axle body. In this case, the hub assembly has an area (hub) which turns relative to the axle body as well as a second region (inner bearing ring) which is arranged or fixed, respectively, substantially stationary relative to the axle body. To put it differently, there is to be no or only very little relative motion between the non-movable part (inner bearing ring) of the hub assembly and the axle body. According to the invention there is provided an intermediate element which is arranged or fixed or mounted, respectively, untwistably or unrotatably or unturnably, respectively, to the axle body around its longitudinal axis. To put it differently, the intermediate element is untwistably arranged or unrotatably secured at the axle body. Furthermore, the intermediate element is provided or arranged, respectively, between the fastening element and the hub assembly. Consequently, an axially acting force or a force acting in the direction of the axle or along the longitudinal axis of the axle body, respectively, can be transferred from the fastening element via the intermediate element onto the hub assembly—in particular its inner bearing ring—which, in turn, is supported on the axle body by a step, for example. Advantageously, there is no axial transmission of force from the intermediate element directly into the axle body, i.e. without an intermediary hub assembly. To put it differently, the intermediate element expediently is not in direct contact with the axle body in the axial direction, but contacts an end wall of the hub assembly or its inner bearing ring, respectively. Such a configuration ensures that the fastening element is decoupled from all forces and torques acting during operation and, moreover, a loosening of the fastening element is inhibited due to a combination of surface friction between the fastening element and the intermediate element and positive locking between the intermediate element and the axle body. According to the invention, the forces and torques generated by the wheel during operation, which would be transmitted via the hub into the fastening element and would lead to a loosening of the fastening element in the case of a direction of turning contrary to the thread direction of the fastening element, are transmitted from the hub into the intermediate element by means of friction, and the intermediate element in turn transmits the forces and torques into the axle body by means of the untwistable arrangement. Hereby, it is achieved that the fastening element is decoupled from (loosening) forces and torques generated during operation and that vibrations produced during operation as well as other influencing factors are compensated. A loosening of the fastening element is inhibited due to the fact that the loosening forces and torques acting on the fastening element are transmitted by means of the friction between the fastening element and the intermediate element into the latter which, in turn, transmits the forces and torques into the axle body as a result of the untwistable arrangement.

Advantageously, the intermediate element is formed as a ring-shaped body. To put it differently, the intermediate element can be formed as a disc-like body. Expediently, this body has in its center an opening or aperture, respectively, through which the axle body may extend. Expediently, the opening or aperture, respectively, has a configuration which corresponds to the configuration of the axle body. In particular, the inner circumference of the intermediate element is essentially congruent with the outer circumference or the outer periphery, respectively, of the axle body. The outer circumference of the intermediate element can be dimensioned such that the intermediate element and an inner bearing ring of the hub assembly overlap at least over a partial area in the radial direction.

Preferably, the intermediate element is guided axially slidable on the axle body. To put it differently, the intermediate element can be displaced or shifted along the longitudinal extension or longitudinal axis or in the longitudinal direction, respectively, of the axle body. This displaceability advantageously is possible at least over a partial area along the axle body, in particular in its end region, in which an engagement section for the fastening element may be provided.

In a preferred embodiment, the intermediate element has at its inner circumference an engaging means which is designed to engage with an engaging means on the axle body. The engaging means can be formed integrally or as a single piece with the intermediate element or the axle body, respectively, or they can also be formed separate therefrom or in several pieces, respectively. The engaging means ensure that the intermediate element can be arranged at the axle body in a particularly untwistable manner.

Expediently, the engaging means of the intermediate element is formed as at least a radial projection and the engaging means of the axle body is formed as at least a radical recess. It is a matter of course that a configuration in which the engaging means of the intermediate element is formed as at least a radial recess and the engaging means of the axle body is formed as at least a radial projection or hybrid forms thereof can also be provided and that these are equivalent and achieve the same result. Expediently, the radial projection and the radial recess are essentially formed to be congruent or to fit each other in terms of shape and size. In a particularly preferred embodiment also a plurality of engaging means can be provided which are preferably distributed equally around the circumference. It is a matter of course that the engaging means can have any desired shape and size. In particular, the projection can project so much that the relation between the projection projecting beyond the inner circumference of the intermediate element or the outer circumference of the axle body, respectively, and the outer circumference of the axle body or the inner circumference of the intermediate element, respectively, may be between 0.1 and 0.001, preferably between 0.07 and 0.02, and particularly preferably about 0.05.

Preferably, the engaging means of the axial body is formed as an axially extending groove or an axially extending projection, respectively. Particularly preferably, the radial recess can be formed as an axially extending groove. The groove or the projection can extend up to the end face of the axle body or only over a defined distance.

Preferably, the hub assembly has an inner bearing ring at which an outer bearing ring or a hub, respectively, is arranged rotatably by means of at least one bearing body. Expediently, the bearing body is formed as a rolling element which can have the configuration of a cylinder or (truncated) cone. The inner bearing ring can be formed as a single piece or consist of several parts, which expediently are lined up axially and connected to one another by means of clip elements.

Expediently, the intermediate element and the inner bearing ring are connected to one another untwistably or unrotatable. This ensures not only that the intermediate element is fixed unrotatably to the axle body but also that the inner bearing ring of the hub assembly is fixed in relation to the axle body in the direction of rotation. Consequently, a “wandering” of the inner bearing ring on the axle body can be avoided, which reduces wear on the wheel bearing. When using a multi-piece inner bearing ring, it is possible to connect the intermediate element and a distal inner bearing ring untwistably. The untwistable connection is possible by means of welding or adhesion, for example. It is also conceivable to achieve the untwistable connection by means of positive locking and/or frictional locking and/or material closure.

In a preferred embodiment, the intermediate element is formed separately from the hub assembly. To put it differently, the intermediate element and the hub assembly are separate from one another or formed as several parts or pieces, respectively. An advantage hereof is that production costs can be saved.

In an alternative embodiment, the intermediate element and the inner bearing ring or the distal part of the hub assembly, respectively, are formed as a single piece. This makes it possible to secure the inner bearing ring particularly unrotatably in relation to the axle body.

In a preferred embodiment, the fastening element and/or the intermediate element have in the area of their mutual contact surfaces a surface design which increases friction. This can be achieved either by means of the material of the fastening element and the intermediate element themselves and/or on the other hand by the design of the surface. Thus, the contact surfaces of the intermediate element with the fastening element or of the fastening element with the intermediate element can have a rough surface (e.g. due to knurling), for example. It is also conceivable to provide the contact surface of the fastening element with an uneven or rough surface configuration and to design the intermediate element in the area of its contact surface of a flowable or soft material so that after assembly of the wheel bearing between the fastening element and the intermediate element the fastening element presses itself into the intermediate element, which results in positive locking. In addition, it is conceivable to make an adhesive connection between the fastening element and the intermediate element by means of an adhesive or glue.

Preferably, the fastening element is formed as a hub axle nut. It has at its inner circumference a thread which acts together with the thread on the outer circumference of the axle body. As a matter of course, the fastening element can also be fastened to the axle body by means of a bayonet joint. The fastening element can also be designed as a clamping ring or bracket.

In a preferred embodiment, the wheel bearing is provided at both ends of the axle body, wherein the fastening element is fixed to the axle body—in the driving direction—preferably on the left-hand side of the axle by means of a left-turning thread of the axle body and on the right-hand side of the axle by means of a right-turning thread of the axle body. This ensures an additional securing of the fastening element due to the forces and torques acting on the fastening element during operation.

Further features and advantages of the invention are described below with reference to the accompanying figures of preferred embodiments of the wheel bearing according to the invention, wherein individual features of individual embodiments may be combined with each other.

### BRIEF DESCRIPTION OF THE DRAWINGS

FIG. 1 is a cross-sectional view of a preferred embodiment of the wheel bearing according to the invention.

FIG. 2 is a top view of a preferred embodiment of an intermediate element according to the invention.

### DESCRIPTION OF THE PREFERRED EMBODIMENTS

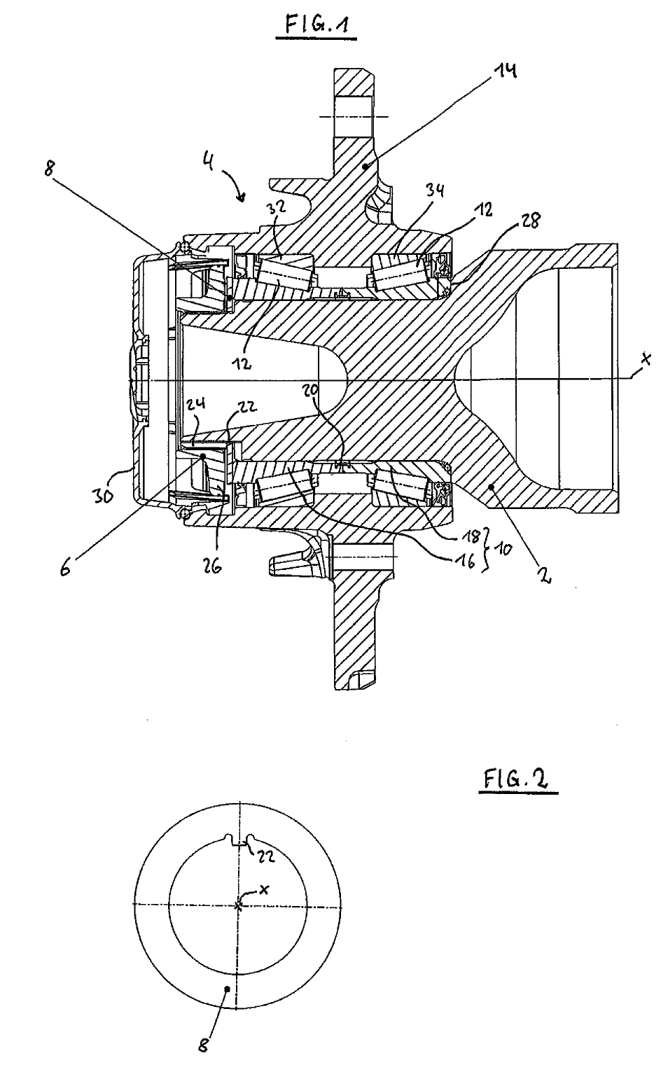

FIG. 1 is a cross-sectional view of an exemplary preferred embodiment of a wheel bearing for vehicle axles according to the invention. The wheel bearing comprises an axle body 2, a hub assembly 4, a fastening element 6 as well as an intermediate element 8.

Such a wheel bearing is mainly used for heavy trailer axles or commercial vehicles. At the end of the axle body 2 or the axle stub, respectively, there is a bearing unit. In the embodiment shown, it is formed as a closed compact rolling contact bearing and comprises an inner bearing ring 10, at which a wheel hub 14 is arranged by means of bearing bodies 12. In the embodiment shown, the inner bearing ring 10 consists of a distal inner bearing ring 16 and a proximal inner bearing ring 18 which are connected to each other by means of a clip ring 20. The outer bearing ring, which is identical for both bearing halves, can be formed by the wheel hub 14. In the embodiment shown, the outer bearing ring is designed as a multi-piece ring and consists of two outer bearing rings 32, 34 axially spaced apart from each other.

As is shown in FIG. 2, the intermediate element 8 has at its inner circumference engaging means 22 designed as a radial projection. The intermediate element 8 is formed as a ring-shaped body whose opening corresponds essentially to the outer circumference of the axle body 2 so that the intermediate element 8 can be slid onto the axle body 2. In so doing, the engaging means 22 of the intermediate element 8 engage with corresponding engaging means 24 provided in the end region of the axle body 2, which engaging means 24 are formed as a groove extending in the direction of the longitudinal axis x or as an axially extending groove. The fact that the engaging means 22, 24 engage with each other ensures that the intermediate element 8 is arranged at the axle body 2 untwistably or unturnably or unrotatably, respectively.

The fastening element 6 can be designed as a hub axle nut which can be screwed onto the end of the axle body 2. While it is screwed into position, the intermediate element 8 arranged between the fastening element 6 and the inner bearing ring 10 is pressed against a distal end face of the inner bearing ring 10 by means of a collar 26 of the fastening element 6. To put it differently, an axial force is transferred from the collar 26 of the fastening element 6 via the intermediate element 8 to a distal end face of the inner bearing ring 10 which is supported on a shoulder 28 of the axle body 2 in such a way that the inner bearing ring 10 is fastened to the axle body 2.

A hub cap 30 prevents that dirt enters the wheel bearing. Furthermore, within the hub cap 30 a grease filling may be provided to lubricate the wheel bearing system.

### LIST OF REFERENCE SIGNS

2 axle body
4 hub assembly
6 fastening element
8 intermediate element
10 inner bearing ring
12 bearing body
14 wheel hub
16 distal inner bearing ring
18 proximal inner bearing ring
20 clip ring
22 engaging means
24 engaging means
26 collar
28 shoulder
30 hub cap
32 distal outer bearing ring
34 proximal outer bearing ring
x longitudinal axis

The invention claimed is:

1. A wheel bearing for vehicle axles, in particular of a commercial vehicle or a land vehicle, comprising:
an axle body;
a hub assembly, which is arranged at the axle body;
a fastening element to fix the hub assembly to the axle body; and
an intermediate element;
wherein the intermediate element is arranged untwistably at the axle body and provided between the fastening element and the hub assembly.

2. The wheel bearing according to claim 1, wherein the intermediate element is formed as a ring-shaped body.

3. The wheel bearing according to any claim 1, wherein the intermediate element is guided axially slidable on the axle body.

4. The wheel bearing according to claim 1, wherein the intermediate element has an engaging means at its inner circumference which is designed to engage with an engaging means on the axle body.

5. The wheel bearing according to claim 4, wherein the engaging means of the intermediate element is formed as at least a radial projection and the engaging means of the axle body is formed as at least a radial recess.

6. The wheel bearing according to claim 5, wherein the radial recess is formed as an axially extending groove.

7. The wheel bearing according to claim 1, wherein the wheel bearing has an inner bearing ring at which an outer bearing ring or a wheel hub is arranged rotatably by means of at least one bearing body.

8. The wheel bearing according to claim 7, wherein the intermediate element and the inner bearing ring of the hub assembly are connected to each other untwistably.

9. The wheel bearing according to claim 1, wherein the intermediate element is formed separately from the hub assembly.

10. The wheel bearing according to claim 7, wherein the intermediate element and the inner bearing ring of the hub assembly are formed as a single piece.

11. The wheel bearing according to claim 1, wherein the fastening element and/or the intermediate element in the area of their mutual contact surfaces have a surface design which increases friction.

12. The wheel bearing according to claim 1, wherein the fastening element is formed as a hub axle nut.

13. The wheel bearing according to claim 1, which is provided at both ends of the axle body, wherein the fastening element is fixed to the axle body on the left-hand axle side by means of a left-turning thread and on the right-hand axle side by means of a right-turning thread of the axle body.
